(19) United States
(12) Patent Application Publication
(10) Pub. No.: US 2024/0034409 A1
(43) Pub. Date: Feb. 1, 2024

(54) METHODS AND SYSTEMS FOR PROVIDING TRAILER GUIDANCE TO AN OPERATOR OF A VEHICLE

(71) Applicant: GM GLOBAL TECHNOLOGY OPERATIONS LLC, Detroit, MI (US)

(72) Inventors: Steffen P. Lindenthal, Oshawa (CA); Utkarsh Saini, Pickering (CA); Giuseppe Petralito, Whitby (CA)

(73) Assignee: GM GLOBAL TECHNOLOGY OPERATIONS LLC, Detroit, MI (US)

(21) Appl. No.: 17/814,891

(22) Filed: Jul. 26, 2022

(51) Int. Cl. B62D 15/02; G06V 20/56; B60Q 9/00

(52) U.S. Cl. CPC B62D 15/029; G06V 20/56; B60Q 9/00; G01C 9/00

(57) ABSTRACT

Methods and systems are provided for providing guidance to an operator of a vehicle when a vehicle is towing a trailer with a boat. In one embodiment, a method includes: storing, in a data storage device, change in height data associated with the vehicle and the trailer; computing, by a processor, a float point of the boat along a boat ramp at a launch site based on the change in height data stored in the data storage device; and generating, by the processor, guidance data based on a location of the vehicle and the float point.

### INTRODUCTION

The technical field generally relates to vehicles and, more specifically, to methods and systems for providing guidance to operators of vehicles towing a trailer with a boat.

Autonomous, semi-autonomous and conventional vehicles can be designed to accommodate the towing or trailering of various loads that include without limitation: flatbeds, enclosed trailers, cargo hoppers, campers, boats, and sometimes other motorized vehicles. Also, a multitude of different trailer hitches can be used in the trailering operations such as gooseneck hitches, weight distribution hitches, pintle hitches, receiver hitches, and 5th wheel hitches. Each configuration of trailer type and hitch type presents different vehicle dynamics.

Reversing a trailer and having the trailer finish in a desired location can be a daunting task for many drivers. For example, reversing a trailer carrying a boat down a boat ramp tend to be an area of stress and anxiety due to a compounding effect of unfamiliarity with the process at the ramp, slippery or steep ramp conditions, aligning the trailer with a dock, keeping the trailer straight, knowing when to stop, and potential hazards to equipment.

Accordingly, it is desirable to provide methods and systems for providing guidance to drivers of vehicles when towing a trailer with a boat, in particular when reversing the trailer. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for providing guidance to an operator of a vehicle when a vehicle is towing a trailer with a boat. In one embodiment, a method includes: storing, in a data storage device, change in height data associated with the vehicle and the trailer; computing, by a processor, a float point of the boat along a boat ramp at a launch site based on the change in height data stored in the data storage device; and generating, by the processor, guidance data based on a location of the vehicle and the float point.

In various embodiments, the method includes computing the change in height data based on a location of a water line associated with the ramp, an incline of the ramp, and a distance travelled to float the boat.

In various embodiments, the method includes determining the location of the water line based on image recognition methods.

In various embodiments, the method includes determining the location of the water line based on marker data associated with user input.

In various embodiments, the method includes receiving the location of the water line as crowd sourced data.

In various embodiments, the method includes determining the incline of the ramp based on inertial measurement unit data.

In various embodiments, the method includes receiving the incline of the ramp as crowd sourced data.

In various embodiments, the guidance data includes an indication of at least one of the boat ramp being too shallow, the boat ramp being too steep, and the boat ramp is safe to proceed.

In various embodiments, the guidance data includes one or more optimal launch sites.

In various embodiments, the guidance data includes an indication to at least one of keep going, how far to go, when to stop, and when the vehicle has gone too far.

In another embodiment, a system includes: a computer readable medium configured to store profile data associated with the boat and trailer; and a computer system onboard the vehicle and configured to, by a processor: store change in height data associated with the boat and trailer; compute a float point of the boat along a boat ramp at a launch site based on the change in height data stored in the data storage device; and generate guidance data based on a location of the vehicle and the float point.

In various embodiments, the computer system is further configured to compute the change in height data based on a location of a water line associated with the ramp, an incline of the ramp, and a distance travelled to float the boat.

In various embodiments, the computer system is further configured to determine the location of the water line based on image recognition methods.

In various embodiments, the computer system is further configured to determine the location of the water line based on marker data associated with user input.

In various embodiments, the computer system is further configured to receive the location of the water line as crowd sourced data.

In various embodiments, the computer system is further configured to determine the incline of the ramp based on inertial measurement unit data.

In various embodiments, the computer system is further configured to receive the incline of the ramp as crowd sourced data.

In various embodiments, the guidance data includes an indication of at least one of the boat ramp being too shallow, the boat ramp being too steep, and the boat ramp is safe to proceed.

In various embodiments, the guidance data includes one or more optimal launch sites.

In various embodiments, the guidance data includes an indication to at least one of keep going, how far to go, when to stop, and when the vehicle has gone too far.

### DESCRIPTION OF THE DRAWINGS

The present disclosure will hereinafter be described in conjunction with the following drawing figures, wherein like numerals denote like elements, and wherein:

FIG. 1 is a functional block diagram of a vehicle that includes a guidance system for providing guidance when the vehicle is towing a trailer, in accordance with various embodiments;

FIG. 2 is a dataflow diagram illustrating aspects of the guidance system of the vehicle of FIG. 1, in accordance with various embodiments;

FIGS. 3A and 3B are side perspective views of the vehicle and the trailer illustrating various parameters used by the guidance system, in accordance with various embodiments; and

FIGS. 4 and 5 are flowcharts of processes for providing guidance as performed by the guidance system of the vehicle of FIGS. 1 and 2, in accordance with exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

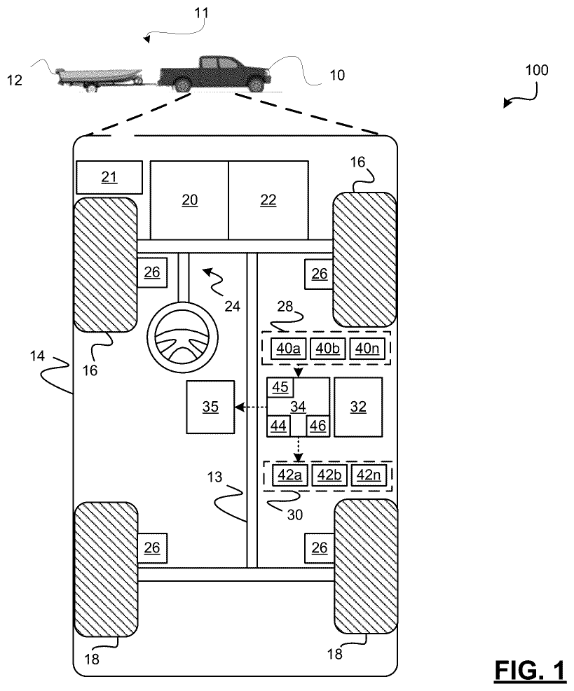

With reference to FIG. 1, a guidance system shown generally at 100 is associated with a vehicle 10 and a trailer 12 in accordance with various embodiments. As can be appreciated, the trailer 12 may any type of towable application having one or more wheels and configured to haul a boat and is not limited to any one embodiment. The vehicle 10 is configured to couple to and connect to the trailer 12 via a connection apparatus 11 and is configured to tow the trailer 12. In various embodiments, the connection apparatus 11 comprises a hitch. In various embodiments, the connection apparatus 11 further comprises a wiring harness configured to communicate power and/or communication signals to and from components of the trailer 12. As described in greater detail further below, the guidance system 100 includes a computer system configured to assist drivers of the vehicle 10 with reversing the trailer 12, for example when reversing the trailer down a boat ramp, by conducting a safety check and guiding an operator to an optimal and compatible launch location. As will be discussed in more detail below, the guidance system 100 conducts the safety check and generates guidance data based on dynamically stored information associated with the vehicle 10 and the particular boat launch site.

In various embodiments, the vehicle 10 comprises an automobile. The vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles in certain embodiments. In various embodiments, the vehicle may also comprise other types of mobile platforms capable of towing and is not limited to an automobile.

As depicted in FIG. 1, the exemplary vehicle 10 generally includes a chassis 13, a body 14, front wheels 16, and rear wheels 18. The body 14 is arranged on the chassis 13 and substantially encloses components of the vehicle 10. The body 14 and the chassis 13 may jointly form a frame. The wheels 16-18 are each rotationally coupled to the chassis 13 near a respective corner of the body 14.

The vehicle 10 generally includes a propulsion system 20, a transmission system 22, a steering system 24, a brake system 26, a sensor system 28, an actuator system 30, at least one data storage device 32, at least one controller 34, and a display system 35. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior and/or interior environment of the vehicle and/or of the vehicle itself. The sensing devices 40a-40n can include, but are not limited to, radars, lidars, global positioning systems (GPS), optical cameras, thermal cameras, ultrasonic sensors, inertial measurement units (IMU), pressure sensors, position sensors, speed sensors, and/or other sensors. In various embodiments, the sensor system 28 includes at least a camera 40a configured to sense an environment at or near a rear portion of the vehicle 10 and to generate image data based thereon, a GPS sensor configured to determine time and location data of the vehicle 10 and to generate GPS data based thereon, and an IMU sensor configured to determine a position of the vehicle 10 (e.g., yaw, pitch, and roll) and to generated IMU data based thereon.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in controlling the vehicle 10. In various embodiments, the data storage device 32 stores defined values for controlling the vehicle. As can be appreciated, the data storage device 32 may be part of the controller 34, separate from the controller 34, or part of the controller 34 and part of a separate system.

The controller 34 includes at least one processor 44, a communication bus 45, a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10. The bus 45 serves to transmit programs, data, status and other information or signals between the various components of the vehicle and/or trailer. The bus 45 can be any suitable physical or logical means of connecting computer systems and components. This includes, but is not limited to, direct hard-wired connections, fiber optics, infrared, and wireless bus technologies.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

In various embodiments, one or more instructions of the controller 34 are embodied in the guidance system 100 and, when executed by the processor 44, receive data from the sensor system 28 and process the data in order to generate display data for display by the display system 35. In various embodiments, as will be discussed in more detail below, the display data 200 includes guidance data including image data 202 from the camera 40a as well as dynamically determined textual and/or visual information that guides users to or away from boat launch sites, and that guides users while reversing down the boat ramp.

As can be appreciated, that the controller 34 may otherwise differ from the embodiment depicted in FIG. 1. For example, the controller 34 may be coupled to or may otherwise utilize one or more remote computer systems and/or other control systems, for example as part of one or more of the above-identified vehicle devices and systems. It will be appreciated that while this exemplary embodiment is described in the context of a fully functioning computer system, those skilled in the art will recognize that the mechanisms of the present disclosure are capable of being distributed as a program product with one or more types of non-transitory computer-readable signal bearing media used to store the program and the instructions thereof and carry out the distribution thereof, such as a non-transitory computer readable medium bearing the program and containing computer instructions stored therein for causing a computer processor (such as the processor 44) to perform and execute the program. Such a program product may take a variety of forms, and the present disclosure applies equally regardless of the particular type of computer-readable signal bearing media used to carry out the distribution. Examples of signal bearing media include recordable media such as floppy disks, hard drives, memory cards and optical disks, and transmission media such as digital and analog communication links. It will be appreciated that cloud-based storage and/or other techniques may also be utilized in certain embodiments. It will similarly be appreciated that the computer system of the controller 34 may also otherwise differ from the embodiment depicted in FIG. 1, for example in that the computer system of the controller 34 may be coupled to or may otherwise utilize one or more remote computer systems and/or other control systems.

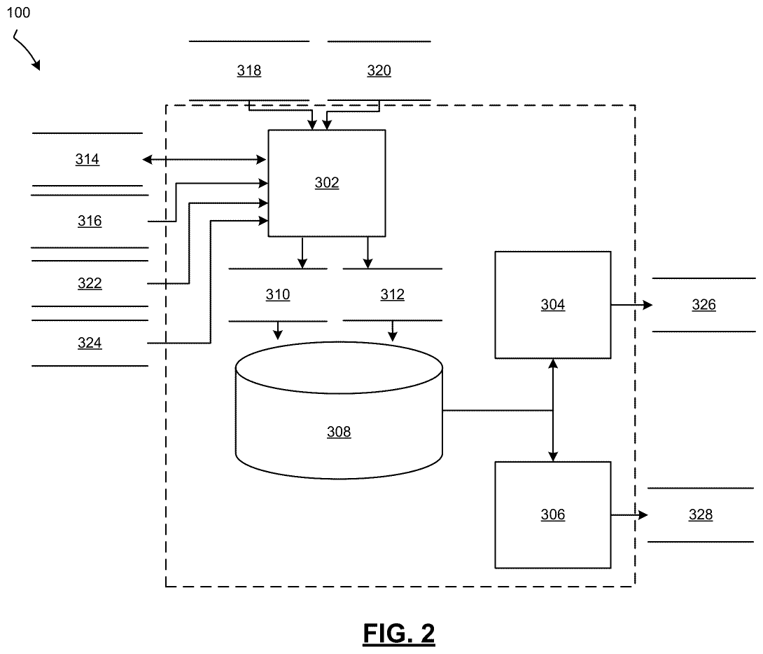

With reference to FIG. 2 and with continued reference to FIG. 1, a dataflow diagram illustrates elements of the guidance system 100 of FIG. 1 in accordance with various embodiments. As can be appreciated, various embodiments of the guidance system 100 according to the present disclosure may include any number of modules embedded within the controller 34 which may be combined and/or further partitioned to similarly implement systems and methods described herein. Furthermore, inputs to the guidance system 100 may be received from the sensor system 28, received from other control modules (not shown) associated with the vehicle 10, and/or determined/modeled by other sub-modules (not shown) within the controller 34 of FIG. 1. Furthermore, the inputs might also be subjected to preprocessing, such as sub-sampling, noise-reduction, normalization, feature-extraction, missing data reduction, and the like. In various embodiments, the guidance system 100 includes a launch data learning module 302, a launch site guidance module 304, a ramp guidance module 306, and a launch data datastore 308.

In various embodiments, the launch data datastore 308 stores profile data 310 associated with various boat launch sites as well as profile data 312 associated with the boat/trailer 12. In various embodiments, the launch site profile data 310 includes, but is not limited to, a water line associated with a boat ramp at the boat launch site, an incline of the boat ramp, and a time of day of the water line. In various embodiments, the boat/trailer profile data 312 includes, but is not limited to, a change in height associated with a float point of the boat/trailer 12, and a water submerge height associated with the vehicle 10.

In various embodiments, the launch data learning module 302 learns the profile data 310, 312 and stores the profile data 310, 312 in the launch data datastore 308. For example, the launch data learning module 302 learns waterline locations, time of day, and incline of a ramp at a launch site and learns floating point characteristics of a boat from a single launch of the boat. In another example, the launch data learning module 302 shares the learned profile data as crowd sourced data 314 and receives and stores crowd sourced data 314 from other vehicles who have visited the launch site.

For example, when an operator has arrived at a launch site and is ready to launch the boat, the launch data learning module 302 determines and stores as launch site profile data 310 a position of the water line along the ramp at the particular time of day and/or season, and determines an stores an incline of the ramp. The launch data learning module 302 stores the information in the profile associated with the ramp at the launch site.

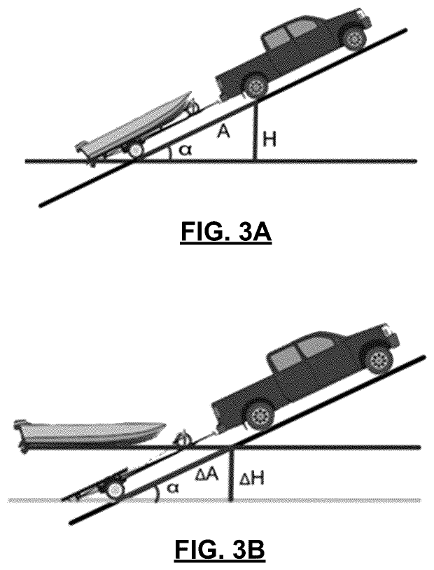

As shown in FIG. 3A, the launch data learning module 302 determines the position of the water line by determining a distance A between the vehicle 10 (e.g., the rear wheel axle) and the water line using sensor data from the vehicle sensors. For example, the distance A may be determined from image data 316 that is processed using one or more image processing methods to identify points in the image where the water line meets the ramp surface. In another example, user input data 318 is received indicating the points where the water line meets the ramp as identified by a user marking the points on an image displayed to the user on the display device via display data 320. In various embodiments, the water line may be marked via an input device and a selectable or moveable line or other marking technique. As can be appreciated, other methods of identifying the points associated with water line may be implemented in various embodiments.

Once the points in the image have been identified, the launch data learning module 302 computes a distance from the vehicle 10 to the identified points and uses the distance along with GPS data 322 to determine the actual location of the water line. For example, the launch data learning module 302 uses the GPS time and location of the vehicle 10 to determine the actual location of the water line relative to the actual location of the vehicle 10 and computes a distance A between the actual location of the vehicle 10 and the actual location of the water line. Thereafter, the launch data learning module 302 uses IMU data 324 to determine the pitch of the vehicle 10. The launch data learning module 302 then associates the pitch with the incline a of the ramp. The determined data is then stored as launch site profile data 310.

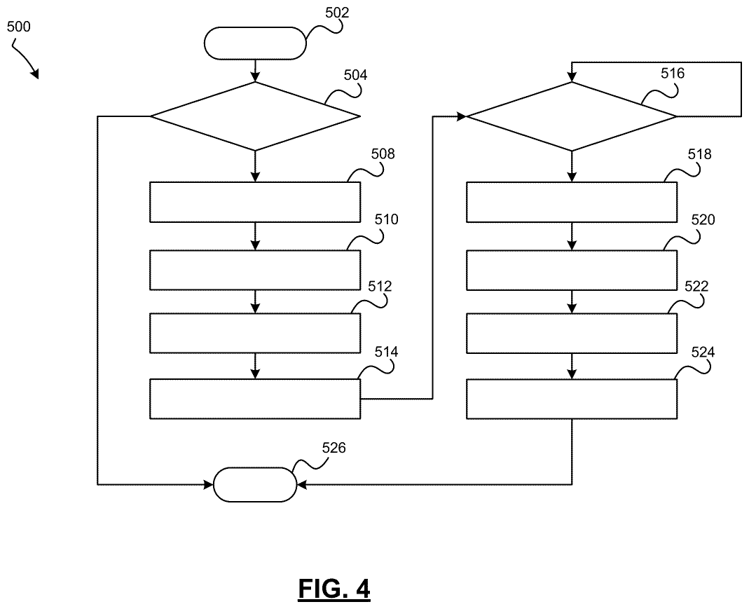

As shown in FIG. 4B, once the user has reversed the vehicle 10 to a point where the boat is floating in the water (i.e., no longer resting on the trailer 12), the launch data learning module 302 determines a float point of the boat in the water. For example, the launch data learning module 302 determines the distance the vehicle 10 has travelled down the ramp to reach the float point, for example, from the GPS data 322 or other vehicle data. The launch data learning module 302 then determines a distance B from the vehicle 10 to the float point from the distance travelled. The launch data learning module 302 then uses trigonometric functions to determine a change in height ΔH based on the distance B, and the previously determined incline a of the ramp. The launch data learning module 302 stores the change in height ΔH information as part of the float point data in the boat/trailer profile data 312.

With reference back to FIG. 2, the launch site guidance module 304 uses the stored profile data 310, 312 to provide guidance data 326 to an operator of the vehicle 10 when choosing a launch site and/or boat ramp for launching and/or retrieval. The guidance data 326 includes but is not limited to, optimal launch sites, potential launch issues, and/or or other launch information for retrieval and/or launch. In various embodiments the launch site guidance module 304 determines which launch sites are associated with an intended body of water and/or in proximity to the vehicle 10 and evaluates the launch site profile data 310 based on the boat/trailer profile data 312 to select the optimal launch site and ramp for a specified time of day. As can be appreciated, the guidance information can be presented in a visual and/or textual format on the display device of the vehicle 10.

In various embodiments, the ramp guidance module 306 evaluates conditions of the ramp of the launch site and the vehicle 10 based on the data stored in the launch data datastore 308 and provides guidance data 328 based thereon. For example, when an operator has arrived at a launch site and is ready to launch the boat, the ramp guidance module 306 determines if the ramp conditions are sufficient to launch the boat without encountering water in the cabin. The ramp guidance module 306 determines the ramp conditions by determining a height when the vehicle 10 will reach the float point. The ramp guidance module 306 then compares the estimated height to the water submerge height from the boat/trailer profile data 312. Based on the comparison, the guidance data 328 includes, but is not limited to, an indication of the ramp being too shallow, and the vehicle may be submerged, the ramp being too steep, and the vehicle may be pulled into the water, and the ramp is safe to proceed, etc. As can be appreciated, the guidance information can be presented in a visual and/or textual format on the display device of the vehicle 10.

In another example, when an operator has arrived at a launch site and is ready to launch the boat, the ramp guidance module 306 determines a float point of the boat along the current ramp and a position of the vehicle relative to the float point. For example, the ramp guidance module 306 retrieves the change in height stored in the boat/trailer profile data 312 of the launch data datastore 308, and the water line location, and the ramp incline stored in the launch site profile data 310 of the launch data datastore 308. The ramp guidance module 306 computes a distance to travel from the water line location in order to achieve the change in height using trigonometric functions and the incline of the ramp, and the change in height. The ramp guidance module 306 sets the float point based on the distance to travel.

As the user is reversing the vehicle 10 towards the float point, the ramp guidance module 306 generates guidance data 328 based on the location of the vehicle 10 relative to the determined float point. For example, the guidance data 328 can include, but is not limited to, guidance information indicating to keep going, how far to go, when to stop, when the vehicle is gone too far, etc. As can be appreciated, the guidance information can be presented in a visual and/or textual format on the display device of the vehicle 10.

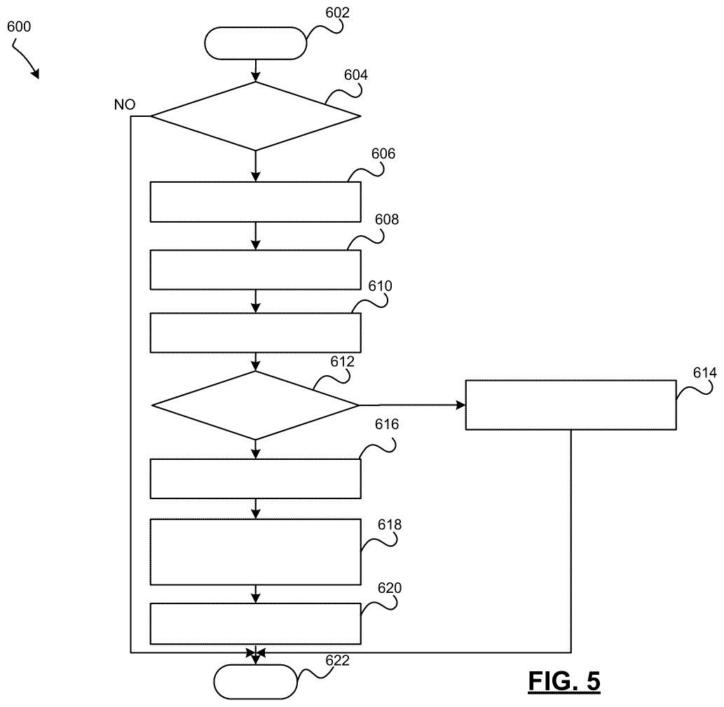

With reference now to FIGS. 4 and 5 and with continued reference to FIGS. 1-2, flowcharts are provided of methods 500, 600 for providing guidance to an operator of a vehicle towing a trailer 12 as performed by the guidance system 100, in accordance with exemplary embodiments. As can be appreciated in light of the disclosure, the order of operation within the methods 500, 600 is not limited to the sequential execution as illustrated in FIGS. 4 and 5, but may be performed in one or more varying orders as applicable and in accordance with the present disclosure. In various embodiments, the methods 500, 600 can be scheduled to run based on one or more predetermined events, and/or can run continuously during operation of the vehicle 10.

The method 500 illustrates embodiments of storing the profile data in the launch data datastore 308 during, for example, a first launch of a boat. In one example, the method 500 may begin at 502. It is determined whether enable conditions are met to determine the profile data 310,312 at 504. For example, it is determined whether the vehicle 10 is in park or reverse in proximity to the launch ramp and/or a boat launch input data is received. When the enable conditions are not met at 504, the method 500 may end at 526. When the enable conditions are met at 504, the water line is identified at 508 based on the vehicle sensor data and/or user input data. The distance A to the identified water line is then determined at 510. The water line location and incline angle is then determined at 512. The water line location and ramp angle are then associated with the time of day and/or season and stored as the launch site profile data 310 in the launch data datastore 308 at 514.

Thereafter, enable conditions for determining the change in height and float point of the boat are evaluated at 516. For example, it is determined whether the vehicle gear or range has changed from reverse to park and/or boat launch input data is received. When the enable conditions are not met at 516, the method 500 continues with evaluating the enable conditions at 516. When the enable conditions are met at 516, the distance traveled is determined at 518 and the float point is determined based thereon at 520. The change in height is determined based on the distance traveled and the ramp incline at 522. The float height data is then stored as the boat/trailer profile data 312 in the launch data datastore at 524. Thereafter, the method 500 may end at 526.

With reference now to FIG. 5 the method 600 illustrates embodiments of providing guidance when launching and/or retrieving the boat based on the stored profile data 310, 312. In one example, the method 600 may begin at 602. It is determined whether enable conditions are met to provide guidance during a launch at 604. For example, it is determined whether the vehicle 10 is in park or reverse in proximity to the launch and/or a boat launch input data is received. When the enable conditions are not met at 604, the method 600 may end at 622. When the enable conditions are met at 604, the launch site profile data 210 is retrieved at 606. The distance to the water line location is determined at 608. The float point height is then computed based on the water line at 610. If the float point height is not OK at 612, guidance data 328 is generated to notify the operator that the vehicle will be submerged at 614 and the method 600 may end at 622.

If, however, the float point height is OK at 612, the float point is computed based on the change in float height of the trailer/boat profile at 615. Guidance data 328 is generated based on the float point and the current location at 618. Any refinements to the change in float height is optionally computed and stored as the profile data in the launch data datastore 308 at 620. Thereafter, the method 600 may end at 622.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof

What is claimed is:

1. A method for providing guidance when a vehicle is towing a trailer with a boat, comprising:
storing, in a data storage device, change in height data associated with the vehicle and the trailer;
computing, by a processor, a float point of the boat along a boat ramp at a launch site based on the change in height data stored in the data storage device; and
generating, by the processor, guidance data based on a location of the vehicle and the float point.

2. The method of claim 1, further comprising computing the change in height data based on a location of a water line associated with the ramp, an incline of the ramp, and a distance travelled to float the boat.

3. The method of claim 2, further comprising determining the location of the water line based on image recognition methods.

4. The method of claim 2, further comprising determining the location of the water line based on marker data associated with user input.

5. The method of claim 2, further comprising receiving the location of the water line as crowd sourced data.

6. The method of claim 2, further comprising determining the incline of the ramp based on inertial measurement unit data.

7. The method of claim 2, further comprising receiving the incline of the ramp as crowd sourced data.

8. The method of claim 1, wherein the guidance data includes an indication of at least one of the boat ramp being too shallow, the boat ramp being too steep, and the boat ramp is safe to proceed.

9. The method of claim 1, wherein the guidance data includes one or more optimal launch sites.

10. The method of claim 1, wherein the guidance data includes an indication to at least one of keep going, how far to go, when to stop, and when the vehicle has gone too far.

11. A system for providing guidance when a vehicle is towing a trailer with a boat, comprising:
a computer readable medium configured to store profile data associated with the boat and trailer; and
a computer system onboard the vehicle and configured to, by a processor:
store change in height data associated with the boat and trailer;
compute a float point of the boat along a boat ramp at a launch site based on the change in height data stored in the data storage device; and
generate guidance data based on a location of the vehicle and the float point.

12. The system of claim 11, wherein the computer system is further configured to compute the change in height data based on a location of a water line associated with the ramp, an incline of the ramp, and a distance travelled to float the boat.

13. The system of claim 12, wherein the computer system is further configured to determine the location of the water line based on image recognition methods.

14. The system of claim 12, wherein the computer system is further configured to determine the location of the water line based on marker data associated with user input.

15. The system of claim 12, wherein the computer system is further configured to receive the location of the water line as crowd sourced data.

16. The system of claim 12, wherein the computer system is further configured to determine the incline of the ramp based on inertial measurement unit data.

17. The system of claim 12, wherein the computer system is further configured to receive the incline of the ramp as crowd sourced data.

18. The system of claim 11, wherein the guidance data includes an indication of at least one of the boat ramp being too shallow, the boat ramp being too steep, and the boat ramp is safe to proceed.

19. The system of claim 11, wherein the guidance data includes one or more optimal launch sites.

20. The system of claim 11, wherein the guidance data includes an indication to at least one of keep going, how far to go, when to stop, and when the vehicle has gone too far.
